(19) United States
(12) Patent Application Publication
(10) Pub. No.: US 2025/0282300 A1
(43) Pub. Date: Sep. 11, 2025

(54) VEHICLE CARGO SECURING SYSTEM

(71) Applicant: Ford Global Technologies, LLC, Dearborn, MI (US)

(72) Inventors: Mario Contreras Sosa, Naucalpan (MX); Enrique Emanuel Farias Delgado, Cuautitlan Izcalli (MX); Miguel Angel Fernandez Vergara, Cuautitlan Izcalli (MX); Luis Angel Becerril Cruz, Toluca (MX)

(21) Appl. No.: 18/601,205

(22) Filed: Mar. 11, 2024

(51) Int. Cl. B60R 9/10; B60R 9/06

(52) U.S. Cl. CPC B60R 9/10; B60R 9/06

(57) ABSTRACT

A vehicle cargo securing system includes a plurality of stabilizers each having a stand and a base. The stands are pivotably coupled to the bases. The stands are pivotable back-and-forth between a stowed position where the stand is disposed within a groove of a cargo bed floor and a cargo support position where the stand is pivoted to a position where the stand projects out of the groove and away from the cargo bed floor.

### TECHNICAL FIELD

This disclosure relates generally to a securing system that is used to secure cargo such as, for example, bicycles and motorcycles.

### BACKGROUND

Vehicles can include many areas utilized to transport cargo. Pickup trucks, for example, include a cargo bed. Systems can be utilized to secure cargo within the cargo bed.

### SUMMARY

In some aspects, the techniques described herein relate to a vehicle cargo securing system, including: a plurality of stabilizers each having a stand and a base, the stand pivotably coupled to the base, the stand pivotable back-and-forth between a stowed position where the stand is disposed within a groove of a cargo bed floor and a cargo support position where the stand is pivoted to a position where the stand projects out of the groove and away from the cargo bed floor.

In some aspects, the techniques described herein relate to a vehicle cargo securing system, wherein the stand and the cargo bed floor are disposed along planes that are aligned with each other when the stand is in the stowed position, where the stand and the cargo bed floor are disposed along planes that are angled relative to each other when the stand is in the cargo support position.

In some aspects, the techniques described herein relate to a vehicle cargo securing system, wherein each of the stabilizers within the plurality of stabilizers includes a hinge pivotably coupling the stand to the base.

In some aspects, the techniques described herein relate to a vehicle cargo securing system, wherein the stand is lockable in the cargo support position.

In some aspects, the techniques described herein relate to a vehicle cargo securing system, wherein the base is secured to the cargo bed floor with at least one mechanical fastener.

In some aspects, the techniques described herein relate to a vehicle cargo securing system, wherein each of the stabilizers within the plurality of stabilizers includes at least one magnet that holds the stand in the stowed position.

In some aspects, the techniques described herein relate to a vehicle cargo securing system, wherein the plurality of stabilizers includes a first stabilizer and a second stabilizer that are configured to support a wheel of a vehicle that is between the first stabilizer and second stabilizer when both the stand of the first stabilizer is in the cargo support position and the stand of the second stabilizer is in the cargo support position.

In some aspects, the techniques described herein relate to a vehicle cargo securing system, further including a strap coupled to the stand of the first stabilizer and to the stand of the second stabilizer when both the stand of the first stabilizer is in the cargo support position and the stand of the second stabilizer is in the cargo support position, the strap extending between a plurality of spokes of the wheel of the vehicle.

In some aspects, the techniques described herein relate to a vehicle cargo securing system, wherein the vehicle is a bicycle and the wheel is a front wheel of the bicycle.

In some aspects, the techniques described herein relate to a vehicle cargo securing system, wherein the plurality of stabilizers are a plurality of floor-mounted stabilizers that are secured to the cargo bed floor adjacent to a cargo bed wall, and further including at least one wall-mounted stabilizer secured to an upper region of the cargo bed wall, the plurality of floor-mounted stabilizers configured to interface with a lower portion of the wheel, the at least one wall-mounted stabilizer configured to interface with an upper portion of the wheel.

In some aspects, the techniques described herein relate to a vehicle cargo securing system, wherein the at least one wall-mounted stabilizer includes a mounting bracket and a stabilizing bracket that is pivotably coupled to the mounting bracket, the at least one wall-mounted stabilizer further including a strap that is anchored to the mounting bracket and is configured to extend through a plurality of spokes of the wheel of the vehicle.

In some aspects, the techniques described herein relate to a vehicle cargo securing system, wherein the cargo bed wall is a front wall of the cargo bed.

In some aspects, the techniques described herein relate to a vehicle cargo securing method, including: pivoting a first stand of a first stabilizer from a stowed position to a cargo support position, the first stand received within a first groove of a cargo bed floor when the first stand is in the stowed position, the first stand in the cargo support position pivoted to project out of the first groove and away from the cargo bed floor; pivoting a second stand of a second stabilizer from a stowed position to a cargo support position, the second stand received within a second groove of a cargo bed floor when the second stand is in the stowed position, the second stand in the cargo support position pivoted to project out of the second groove and away from the cargo bed floor; and supporting a wheel of a vehicle between the first stand of the first stabilizer in the cargo support position and the second stand of the second stabilizer in the cargo support position.

In some aspects, the techniques described herein relate to a vehicle cargo securing method, wherein the wheel is a front wheel of a two-wheeled vehicle.

In some aspects, the techniques described herein relate to a vehicle cargo securing method, wherein the wheel is a front wheel of a bicycle.

In some aspects, the techniques described herein relate to a vehicle cargo securing method, further including supporting the wheel using a strap that is connected to the first stand and the second stand and extends through a plurality of spokes of the wheel.

In some aspects, the techniques described herein relate to a vehicle cargo securing method, further including securing a first base of the first stabilizer to the cargo bed floor adjacent to a cargo bed wall, and securing a second base of the second stabilizer to the cargo bed floor adjacent to the cargo bed wall.

In some aspects, the techniques described herein relate to a vehicle cargo securing method, further including supporting an upper portion of the wheel using at least one wall-mounted stabilizer secured to an upper region of the cargo bed wall.

In some aspects, the techniques described herein relate to a vehicle cargo securing method, further including supporting the upper region using a strap of the at least one wall-mounted stabilizer, the strap extending through spokes of the wheel of the vehicle.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a perspective view of a vehicle having a cargo bed and carrying cargo that is secured using a cargo securing system according to an exemplary aspect of the present disclosure.

FIG. 2 shows a perspective view of the cargo securing system shown in FIG. 1 with the cargo securing system having stands of stabilizers in a stowed position.

FIG. 3 illustrates a section view at line 3-3 in FIG. 2 showing the stands in the stowed position and a cargo support position of the stands shown in broken lines.

FIG. 4 illustrates the perspective view of the cargo securing system of FIG. 2 having the stands of the stabilizers in a cargo support position.

FIG. 5 illustrates the perspective view of the cargo securing system of FIG. 4 having the stands of the stabilizers in the cargo support position and with cargo.

FIG. 6 illustrates a close-up perspective view of the cargo securing system of FIG. 5.

FIG. 7 illustrates a top view of the cargo securing system in the position of FIG. 5 along with other stabilizers and cargo.

### DETAILED DESCRIPTION

This disclosure details exemplary embodiments of a vehicle cargo securing system. The embodiments utilize the securing systems to secure a bicycle. In other examples, the securing system secures other types of cargo.

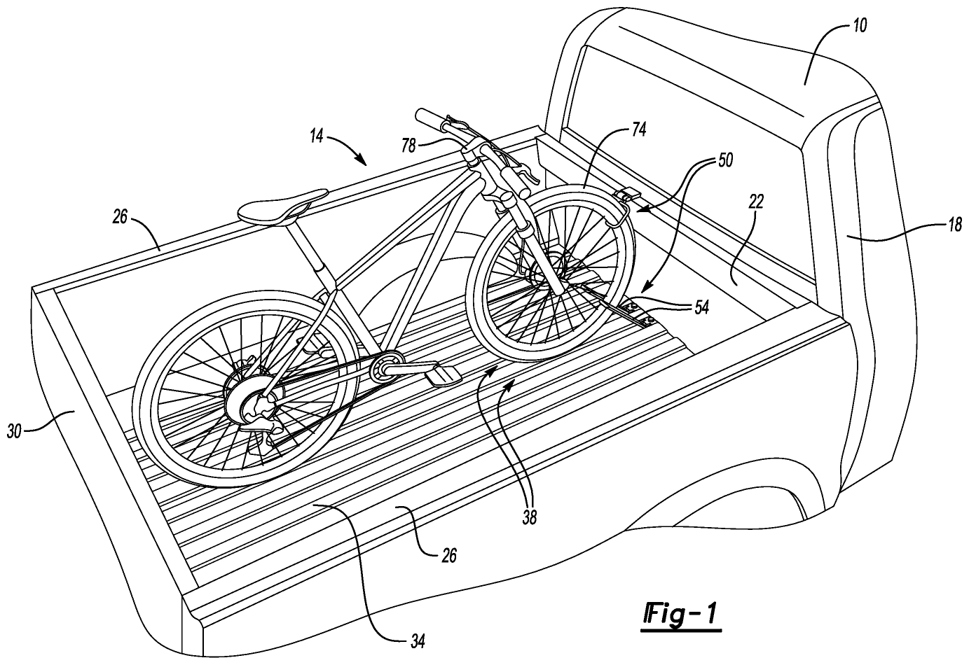

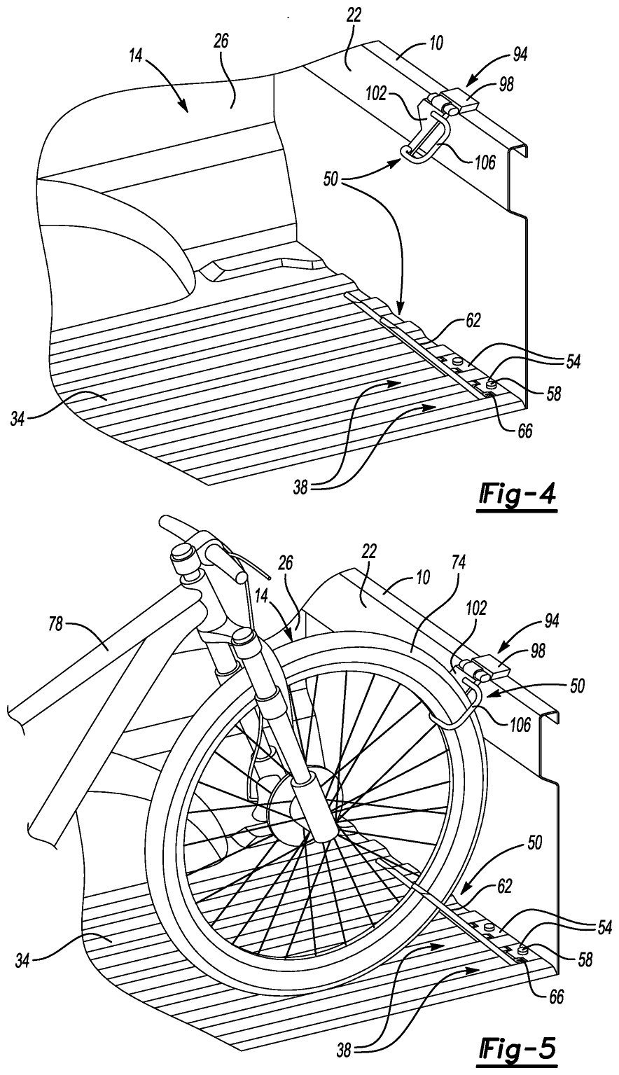

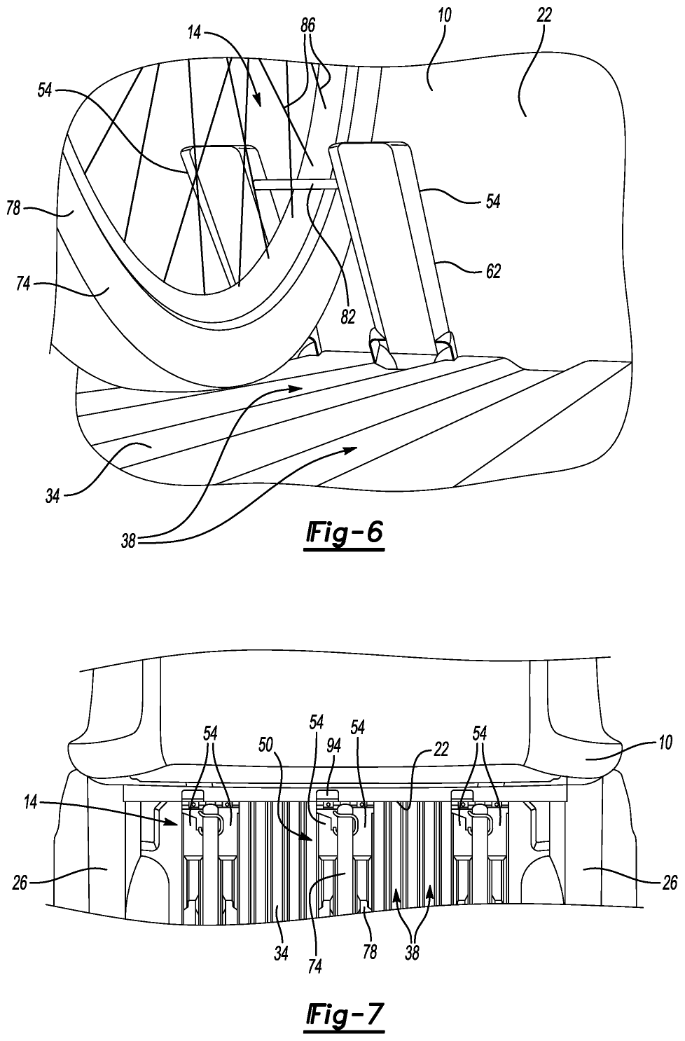

With reference to FIGS. 1-6, a vehicle 10 includes a cargo bed 14 aft of a passenger compartment 18. The cargo bed 14 includes a front wall 22, opposing sidewalls 26, and a tailgate 30. The cargo bed 14 includes a cargo bed floor 34 having a plurality of grooves 38 or corrugations. The grooves 38 can enhance structural integrity of the floor 34 and the overall cargo bed 14.

A vehicle cargo securing system 50 is used to secure cargo within the cargo bed 14. That cargo securing system 50 can provide tie-down locations for securing cargo.

In this exemplary embodiment of this disclosure, the vehicle cargo securing system 50 includes a plurality of stabilizers 54 mounted to the cargo bed floor 34. In this particular embodiment, the securing system 50 utilizes two stabilizers 54.

Each of the stabilizers 54 includes a base 58 that is pivotably connected to a stand 62. The base 58 and the stand 62 can be a rigid polymer-based material.

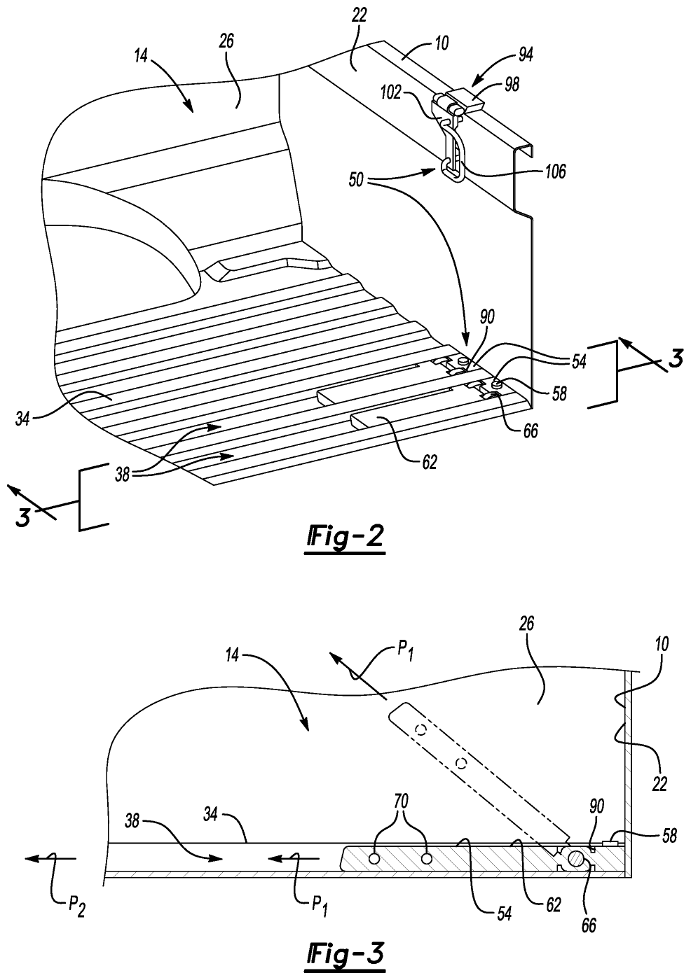

The stabilizers 54 additionally include a hinge 66 that pivotably connects together the base 58 and the stand 62. The stand 62 of each of the stabilizers 54 is pivotable relative to the respective base 58 back-and-forth between a stowed position shown in FIGS. 2 and 3 and a cargo support position shown in FIGS. 1 and 4-6.

In the stowed position, the stands 62 are each disposed within one of the grooves 38 of the cargo bed floor 34. In the stowed position, the example stands 62 along with the remaining portions of the stabilizers 54 are fully received within the grooves 38. That is, the example stabilizers 54 do not protrude above the cargo bed floor 34 when the stands 62 are in the stowed position.

When the stands 62 are in the stowed position, the stands 62 are disposed along a plane P₁ that is aligned with a plane P₂ of the cargo bed floor 34. As the stand 62 is disposed within the groove 38 when in the stowed position, the stand 62 does not interfere with cargo when the stabilizers 54 are not needed to secure cargo. That is, a user can load and unload sheets of drywall or plywood from the cargo bed 14 without the stand 62 blocking the sheets from sliding along the cargo bed floor 34.

In the exemplary embodiment, the stands 62 include magnets 70 that help to hold the stands 62 in the stowed position due to the magnetic attraction to the cargo bed floor 34. The magnets 70 can be encapsulated to inhibit corrosion.

In some examples, bumpers are positioned between the stands 62 and the cargo bed floor 34 to dampen movement of the stands 62 back to the stowed position.

To utilize the securing system 50 to secure cargo, the stands 62 are pivoted from the stowed position to the cargo support position shown. The hinge 66 of the stabilizers 54 could be a lockable hinge or a controlled torque hinge so that the stand 62 can maintain itself in the cargo support position.

When in the cargo support position, the plane P₁ is angled relative to the plane P₂ of the cargo bed floor 34. When the stabilizers 54 are in the cargo support position, the stands 62 project out of the respective grooves 38 away from the cargo bed floor 34. A wheel 74 of cargo 78 can be positioned between the stands 62 of the stabilizers 54 to secure the cargo 78. The wheel 74 is stabilized by the stabilizers 54.

In some examples, a strap 82 can connect to the stands 62 of each of the stabilizers 54. The strap 82 can extend through spokes 86 of the front wheel 74. In this example, the cargo 78 is a two-wheeled vehicle, such as a bicycle. The front wheel 74 of the cargo 78 has a plurality of bicycle spokes.

In the exemplary embodiment, the stabilizers 54 are anchored to the cargo bed floor 34 using a plurality of mechanical fasteners 90 that extend through the bases 58 to engage the cargo bed floor 34. As the stabilizers 54 are anchored to the cargo bed floor 34, the stabilizers 54 can be considered floor-mounted stabilizers. The stabilizers 54 can be repositioned at various areas of the cargo bed floor 34 as required.

The exemplary securing system 50 includes at least one wall-mounted stabilizer 94 in addition to the stabilizers 54. In the exemplary embodiment, the wall-mounted stabilizer 94 includes a mounting bracket 98 and a stabilizing bracket 102 that is pivotably coupled to the mounting bracket 98. The wall-mounted stabilizer 94 can additionally include a strap 106 that can loop through spokes 86 of the wheel 74 of the cargo 78.

The wall-mounted stabilizer 94 is configured to interface with an upper portion of the front wheel 74 while the stabilizers 54 are configured to interface with a lower portion of the wheel 74. Upper and lower, for purposes of this disclosure, are with reference to ground in a general orientation of the vehicle 10 during operation when carrying the cargo 78.

The mounting bracket 98 of the wall-mounted stabilizer 94 can be pivotably coupled to the stabilizing bracket 102. This enables the stabilizing bracket 102 to be adjusted to accommodate different sizes and position for the wheels 74.

The wall-mounted stabilizer 94 is coupled directly to the front wall 22 of the cargo bed 14, and in particular, to an upper region-here an upper edge—of the front wall 22. The stabilizers 54 are secured to the cargo bed floor 34 at a position adjacent a bottom of the front wall 22.

Although described in connection with the front wall 22, the securing system 50 of this disclosure could be utilized in connection with other cargo bed walls, such as the sidewalls 26 or even the tailgate 30.

Further, as shown in FIG. 7, a plurality of the cargo securing system 50 could be used to secure respective cargo within the cargo bed 14 at various cross-vehicle positions.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A vehicle cargo securing system, comprising:
a plurality of stabilizers each having a stand and a base, the stand pivotably coupled to the base, the stand pivotable back-and-forth between a stowed position where the stand is disposed within a groove of a cargo bed floor and a cargo support position where the stand is pivoted to a position where the stand projects out of the groove and away from the cargo bed floor.

2. The vehicle cargo securing system of claim 1, wherein the stand and the cargo bed floor are disposed along planes that are aligned with each other when the stand is in the stowed position, where the stand and the cargo bed floor are disposed along planes that are angled relative to each other when the stand is in the cargo support position.

3. The vehicle cargo securing system of claim 1, wherein each of the stabilizers within the plurality of stabilizers includes a hinge pivotably coupling the stand to the base.

4. The vehicle cargo securing system of claim 1, wherein the stand is lockable in the cargo support position.

5. The vehicle cargo securing system of claim 1, wherein the base is secured to the cargo bed floor with at least one mechanical fastener.

6. The vehicle cargo securing system of claim 1, wherein each of the stabilizers within the plurality of stabilizers includes at least one magnet that holds the stand in the stowed position.

7. The vehicle cargo securing system of claim 1, wherein the plurality of stabilizers includes a first stabilizer and a second stabilizer that are configured to support a wheel of a vehicle that is between the first stabilizer and second stabilizer when both the stand of the first stabilizer is in the cargo support position and the stand of the second stabilizer is in the cargo support position.

8. The vehicle cargo securing system of claim 7, further comprising a strap coupled to the stand of the first stabilizer and to the stand of the second stabilizer when both the stand of the first stabilizer is in the cargo support position and the stand of the second stabilizer is in the cargo support position, the strap extending between a plurality of spokes of the wheel of the vehicle.

9. The vehicle cargo securing system of claim 8, wherein the vehicle is a bicycle and the wheel is a front wheel of the bicycle.

10. The vehicle cargo securing system of claim 7, wherein the plurality of stabilizers are a plurality of floor-mounted stabilizers that are secured to the cargo bed floor adjacent to a cargo bed wall, and further comprising at least one wall-mounted stabilizer secured to an upper region of the cargo bed wall, the plurality of floor-mounted stabilizers configured to interface with a lower portion of the wheel, the at least one wall-mounted stabilizer configured to interface with an upper portion of the wheel.

11. The vehicle cargo securing system of claim 10, wherein the at least one wall-mounted stabilizer includes a mounting bracket and a stabilizing bracket that is pivotably coupled to the mounting bracket, the at least one wall-mounted stabilizer further comprising a strap that is anchored to the mounting bracket and is configured to extend through a plurality of spokes of the wheel of the vehicle.

12. The vehicle cargo securing system of claim 10, wherein the cargo bed wall is a front wall of a cargo bed.

13. A vehicle cargo securing method, comprising:
pivoting a first stand of a first stabilizer from a stowed position to a cargo support position, the first stand received within a first groove of a cargo bed floor when the first stand is in the stowed position, the first stand in the cargo support position pivoted to project out of the first groove and away from the cargo bed floor;
pivoting a second stand of a second stabilizer from a stowed position to a cargo support position, the second stand received within a second groove of a cargo bed floor when the second stand is in the stowed position, the second stand in the cargo support position pivoted to project out of the second groove and away from the cargo bed floor; and
supporting a wheel of a vehicle between the first stand of the first stabilizer in the cargo support position and the second stand of the second stabilizer in the cargo support position.

14. The vehicle cargo securing method of claim 13, wherein the wheel is a front wheel of a two-wheeled vehicle.

15. The vehicle cargo securing method of claim 13, wherein the wheel is a front wheel of a bicycle.

16. The vehicle cargo securing method of claim 13, further comprising supporting the wheel using a strap that is connected to the first stand and the second stand and extends through a plurality of spokes of the wheel.

17. The vehicle cargo securing method of claim 13, further comprising securing a first base of the first stabilizer to the cargo bed floor adjacent to a cargo bed wall, and securing a second base of the second stabilizer to the cargo bed floor adjacent to the cargo bed wall.

18. The vehicle cargo securing method of claim 17, further comprising supporting an upper portion of the wheel using at least one wall-mounted stabilizer secured to an upper region of the cargo bed wall.

19. The vehicle cargo securing method of claim 18, further comprising supporting the upper region using a strap of the at least one wall-mounted stabilizer, the strap extending through spokes of the wheel of the vehicle.
